(19) United States
(12) Patent Application Publication
(10) Pub. No.: US 2025/0094826 A1
(43) Pub. Date: Mar. 20, 2025

(54) INFORMATION PROCESSING APPARATUS, PREDICTION APPARATUS, MACHINE LEARNING METHOD, AND LEARNING PROGRAM

(71) Applicant: NEC Corporation, Minato-ku, Tokyo (JP)

(72) Inventors: Yoichi Sasaki, Tokyo (JP); Yuzuru Okajima, Tokyo (JP)

(73) Assignee: NEC Corporation, Minato-ku, Tokyo (JP)

(21) Appl. No.: 18/289,137

(22) PCT Filed: Jul. 5, 2023
(86) PCT No.: PCT/JP2023/024893

§ 371 Date: Nov. 1, 2023

(30) Foreign Application Priority Data
Aug. 4, 2022 (JP) 2022-124955

(51) Int. Cl. G06N 5/01

(52) U.S. Cl. CPC G06N 5/01

(57) ABSTRACT

An information processing apparatus 1 includes: a prediction section 11 that for a training example included in a training example set, calculates a prediction result on the basis of predicted values of k top-ranked decision rules which are among decision rules included in a decision list and whose conditions are satisfied by the training example; and a list determining section 12 that by repeatedly carrying out, until a predetermined condition is satisfied by an objective function including an error term of the prediction result, a process for updating a variable indicative of the decision list, determines the decision list, the variable including a variable indicative of a decision rule which is among the decision rules whose conditions are satisfied and which is given kth priority to be used for prediction. This enables promotion of better decision making by a user on the basis of a higher priority decision rule.

### TECHNICAL FIELD

The present invention relates to, for example, an information processing apparatus that outputs a decision list by machine learning.

### BACKGROUND ART

Prediction by artificial intelligence (AI) with use of black box models such as a deep neural network and a random forest has a difficulty such that it is impossible to explain ground for the prediction.

For this reason, a prediction model called a decision list has attracted attention again as one of pieces of AI that makes it possible explain ground for prediction. A decision list is a list composed of a plurality of if-then rules, as disclosed in Non-patent Literature below. In prediction with use of a decision list, a rule that is among rules whose conditions (“if” of an if-then rule) are satisfied by observation and that is located at the topmost of the decision list is applied so that the prediction is carried out. This enables a single rule to explain a prediction result, and makes it easy for a human to understand how the rule has been selected. A decision list thus has an advantage of making it possible to explain ground for prediction.

### CITATION LIST

### Non-Patent Literature

[Non-patent Literature 1]
Cynthia Rudin, Seyda Ertekin, “Learning customized and optimized lists of rules with mathematical programming” Math. Program. Comput., 2018

### SUMMARY OF INVENTION

### Technical Problem

The technique of Non-patent Literature 1 has problem of being inferior in prediction performance to black box models such as a deep neural network and a random forest. A solution to the problem may be, for example, calculation of a prediction result on the basis of predicted values of k (k is a natural number of not less than 2) decision rules which are among decision rules whose conditions are satisfied by observation and which are top-ranked in a decision list.

However, in a case where an optimal decision list is to be determined by preparing and solving an optimization problem in which a condition that k decision rules top-ranked in a decision list are applied is represented by a variable, k having a greater value results in an increase in number of variables. The increase in number of variables causes a problem of an increase in processing time and/or memory used amount that is/are necessary for determination of a decision list.

An example object of an example aspect of the present invention is to provide, for example, an information processing apparatus in which in determination of a decision list from which a prediction result is calculated on the basis of predicted values of k (k is a natural number of not less than 2) top-ranked decision rules whose conditions are satisfied by observation, an increase in processing time and/or memory used amount that is/are necessary for determination of the decision list is prevented even if k is set to a great value.

### Solution to Problem

An information processing apparatus according to an example aspect of the present invention includes: a prediction means that for a training example included in a training example set, calculates a prediction result on the basis of predicted values of k (k is a natural number of not less than 2) top-ranked decision rules which are among decision rules included in a decision list and whose conditions are satisfied by the training example; and a list determining means that by repeatedly carrying out, until a predetermined condition is satisfied by a value of an objective function including an error term indicative of an error of the prediction result, a process for updating a variable indicative of the decision list, determines the decision list to be output, the variable including a variable indicative of a decision rule which is among the decision rules whose conditions are satisfied and which is given kth priority to be used for prediction.

A machine learning method according to an example aspect of the present invention includes: (a) for a training example included in a training example set, calculating a prediction result on the basis of predicted values of k (k is a natural number of not less than 2) top-ranked decision rules which are among decision rules included in a decision list and whose conditions are satisfied by the training example; and (b) by repeatedly carrying out, until a predetermined condition is satisfied by a value of an objective function including an error term indicative of an error of the prediction result, a process for updating a variable indicative of the decision list, determining the decision list to be output, (a) and (b) each being carried out by at least one processor, the variable including a variable indicative of a decision rule which is among the decision rules whose conditions are satisfied and which is given kth priority to be used for prediction.

A learning program according to an example aspect of the present invention is a learning program for causing a computer to function as: a prediction means that for a training example included in a training example set, calculates a prediction result on the basis of predicted values of k (k is a natural number of not less than 2) top-ranked decision rules which are among decision rules included in a decision list and whose conditions are satisfied by the training example; and a list determining means that by repeatedly carrying out, until a predetermined condition is satisfied by a value of an objective function including an error term indicative of an error of the prediction result, a process for updating a variable indicative of the decision list, determines the decision list to be output, the variable including a variable indicative of a decision rule which is among the decision rules whose conditions are satisfied and which is given kth priority to be used for prediction.

### Advantageous Effects of Invention

According to an example aspect of the present invention, in determination of a decision list from which a prediction result is calculated on the basis of predicted values of k (k is a natural number of not less than 2) top-ranked decision rules whose conditions are satisfied by observation, an increase in processing time and/or memory used amount that is/are necessary for determination of the decision list can be prevented even if k is set to a great value.

### BRIEF DESCRIPTION OF DRAWINGS

FIG. 1 is a block diagram illustrating a configuration of an information processing apparatus according to a first example embodiment.

FIG. 2 is a flowchart showing a flow of a machine learning method according to the first example embodiment.

FIG. 3 is a diagram illustrating an overview of a machine learning method according to a second example embodiment.

FIG. 4 is a diagram for describing prediction with use of a decision list according to the second example embodiment.

FIG. 5 is a block diagram illustrating an example configuration of an information processing apparatus according to the second example embodiment.

FIG. 6 is a flowchart showing a flow of a machine learning method carried out by the information processing apparatus.

FIG. 7 is a flowchart showing a flow of a prediction method carried out by the information processing apparatus.

FIG. 8 is a drawing illustrating an example of a computer which executes instructions of a program that is software realizing functions of information processing apparatuses according to example embodiments and reference examples of the present invention.

FIG. 9 is a diagram illustrating an overview of an information processing system according to a third example embodiment.

FIG. 10 is a block diagram illustrating an example configuration of a prediction apparatus according to the third example embodiment.

FIG. 11 is an example display screen in which a decision rule, a measure, and a prediction result are displayed.

FIG. 12 is a flowchart showing a flow of a process carried out by the prediction apparatus according to the third example embodiment.

### DESCRIPTION OF EMBODIMENTS

### First Example Embodiment

The following description will discuss a first example embodiment of the present invention in detail with reference to the drawings. The first example embodiment is an embodiment serving as a basis for example embodiments described later.

### (Configuration of Information Processing Apparatus 1)

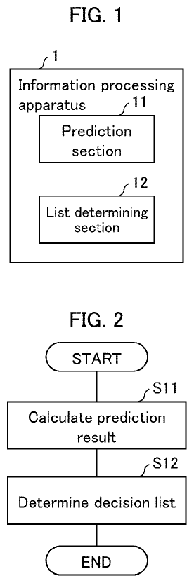

The following description will discuss a configuration of an information processing apparatus 1 according to the present example embodiment with reference to FIG. 1. FIG. 1 is a block diagram illustrating the configuration of the information processing apparatus 1. The information processing apparatus 1 includes a prediction section (prediction means) 11 and a list determining section (list determining means) 12 as illustrated in FIG. 1.

For a training example included in a training example set, the prediction section 11 calculates a prediction result on the basis of predicted values of k (k is a natural number of not less than 2) top-ranked decision rules which are among decision rules included in a decision list and whose conditions are satisfied by the training example.

By repeatedly carrying out, until a predetermined condition is satisfied by a value of an objective function including an error term indicative of an error of the prediction result, a process for updating a variable indicative of the decision list, the list determining section 12 determines the decision list to be output. Note here that the variable includes a variable indicative of a decision rule which is among the decision rules whose conditions are satisfied and which is given kth priority to be used for prediction.

As described above, a configuration is employed such that the information processing apparatus 1 according to the present example embodiment includes: the prediction section 11 that for a training example included in a training example set, calculates a prediction result on the basis of predicted values of k (k is a natural number of not less than 2) top-ranked decision rules which are among decision rules included in a decision list and whose conditions are satisfied by the training example; and the list determining section 12 that by repeatedly carrying out, until a predetermined condition is satisfied by a value of an objective function including an error term indicative of an error of the prediction result, a process for updating a variable indicative of the decision list, determines the decision list to be output, the variable including a variable indicative of a decision rule which is among the decision rules whose conditions are satisfied and which is given kth priority to be used for prediction.

According to the above configuration, a variable indicative of a decision rule which is among decision rules whose conditions are satisfied and which is given kth priority to be used for prediction is used. This does not result in an increase in number of variables even if k has a greater value. Thus, even setting of k to a great value does not require an increase in processing time and/or memory used amount that is/are necessary for determination of a decision list. That is, the above configuration brings about an effect such that in determination of a decision list from which a prediction result is calculated on the basis of predicted values of k (k is a natural number of not less than 2) top-ranked decision rules whose conditions are satisfied by observation, an increase in processing time and/or memory used amount that is/are necessary for determination of the decision list can be prevented even if k is set to a great value. Furthermore, the information processing apparatus 1 can promote better decision making by a user on the basis of a higher priority decision rule.

### (Program)

The foregoing functions of the information processing apparatus 1 can also be realized by a learning program. A learning program according to the present example embodiment causes a computer to function as: a prediction means that for a training example included in a training example set, calculates a prediction result on the basis of predicted values of k (k is a natural number of not less than 2) top-ranked decision rules which are among decision rules included in a decision list and whose conditions are satisfied by the training example; and a list determining means that by repeatedly carrying out, until a predetermined condition is satisfied by a value of an objective function including an error term indicative of an error of the prediction result, a process for updating a variable indicative of the decision list, determines the decision list to be output, the variable including a variable indicative of a decision rule which is among the decision rules whose conditions are satisfied and which is given kth priority to be used for prediction. Thus, the learning program according to the present example embodiment brings about an effect such that in determination of a decision list from which a prediction result is calculated on the basis of predicted values of k (k is a natural number of not less than 2) top-ranked decision rules whose conditions are satisfied by observation, an increase in processing time and/or memory used amount that is/are necessary for determination of the decision list can be prevented even if k is set to a great value.

### (Flow of Machine Learning Method)

The following description will discuss a flow of a machine learning method according to the present example embodiment with reference to FIG. 2. FIG. 2 is a flowchart showing the flow of the machine learning method.

Note that steps of the machine learning method of FIG. 2 may be carried out by a processor of the information processing apparatus 1 or by a processor of another apparatus. Alternatively, the steps may be carried out by processors provided in respective different apparatuses.

In S11, for a training example included in a training example set, the at least one processor calculates a prediction result on the basis of predicted values of k (k is a natural number of not less than 2) top-ranked decision rules which are among decision rules included in a decision list and whose conditions are satisfied by the training example.

In S12, by repeatedly carrying out, until a predetermined condition is satisfied by a value of an objective function including an error term indicative of an error of the prediction result, a process for updating a variable indicative of the decision list, the at least one processor determines the decision list to be output. Note here that the variable includes a variable indicative of a decision rule which is among the decision rules whose conditions are satisfied and which is given kth priority to be used for prediction.

As described above, a configuration is employed such that the machine learning method according to the present example embodiment includes: (a) for a training example included in a training example set, calculating a prediction result on the basis of predicted values of k (k is a natural number of not less than 2) top-ranked decision rules which are among decision rules included in a decision list and whose conditions are satisfied by the training example; and (b) by repeatedly carrying out, until a predetermined condition is satisfied by a value of an objective function including an error term indicative of an error of the prediction result, a process for updating a variable indicative of the decision list, determining the decision list to be output, (a) and (b) each being carried out by at least one processor, the variable including a variable indicative of a decision rule which is among the decision rules whose conditions are satisfied and which is given kth priority to be used for prediction. Thus, the machine learning method according to the present example embodiment brings about an effect such that in determination of a decision list from which a prediction result is calculated on the basis of predicted values of k (k is a natural number of not less than 2) top-ranked decision rules whose conditions are satisfied by observation, an increase in processing time and/or memory used amount that is/are necessary for determination of the decision list can be prevented even if k is set to a great value.

### Second Example Embodiment

The following description will discuss a second example embodiment of the present invention in detail with reference to the drawings. Note that members having functions identical to those of the respective members described in the first example embodiment are given respective identical reference numerals, and a description of those members is not repeated.

### (Overview)

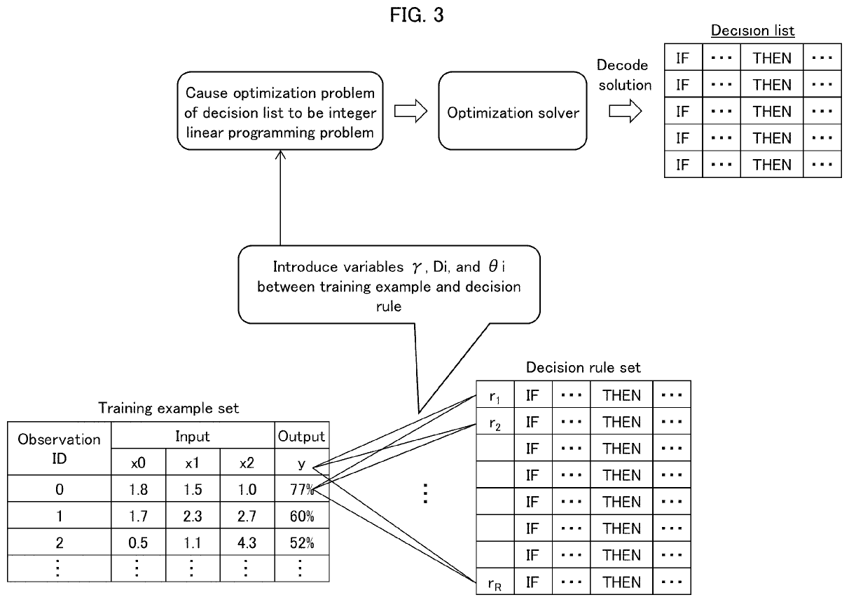

FIG. 3 is a diagram illustrating an overview of a machine learning method according to the present example embodiment. In the machine learning method according to the present example embodiment, a decision list is determined that is to be output and that is composed of a plurality of decision rules extracted from a decision rule set, which is a set of decision rules. Note here that the decision rule is obtained by associating a condition (IF) with a predicted value (THEN) obtained when the condition is satisfied. The decision list is a list of decision rules, the list being composed of a plurality of decision rules extracted from a decision rule set. For example, a decision rule set illustrated in FIG. 3 includes R decision rules from r₁ to r_{R}. A plurality of decision lists can be generated from a single decision rule set.

A training example included in a training example set illustrated in FIG. 3 is obtained by associating, with each other, an observation ID, numerical values of x0 to x2 indicative of an input, and a numerical value of y indicative of an output. It can also be said that the input is observed values. It can also be said that the output y is a label or ground truth data for observation. Note that an observed value is not limited to a numerical value, and may be, for example, “TRUE” (satisfying a predetermined condition) or “FALSE” (not satisfying the predetermined condition). In the example of FIG. 3, a unit of the output y is %. Note, however, that the output y only needs to be represented by a real value, and the unit is arbitrary.

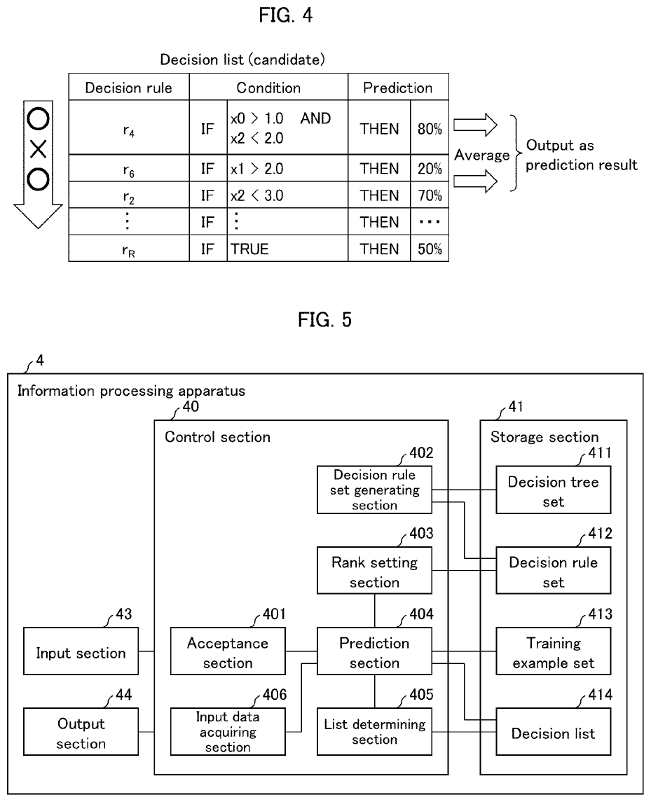

FIG. 4 is a diagram for describing prediction with use of a decision list according to the present example embodiment. FIG. 4 illustrates, as an example of the decision list, a decision list in which decision rules r₄, r₆, r₂, . . . , r_{R} are arranged in this order. The decision rule r₄ has a condition of “x0>1.0 AND x2<2.0” and a predicted value of “80%”. The decision rule r₆ has a condition of “x1>2.0” and a predicted value of “20%”. The decision rule r₂ has a condition of x2<3.0″ and a predicted value of “70%”. The decision rule IR has a condition of “TRUE” and a predicted value of “50%”. The decision rule r_{R}, which is for outputting a predicted value (50% in this example) that is always the same with respect to any input, is called a default rule.

Assume that the decision list of FIG. 4 is used to carry out prediction about a training example whose observation ID in FIG. 3=0. In this case, decision rules are subjected to determination, in order from higher to lower ranks, as to whether the input values “x0=1.8, x1=1.5, and x2=1.0” of the training example satisfy conditions included in the decision list. This process is carried out until the number of decision rules whose conditions are satisfied reaches k (k is a natural number of not less than 2).

Assume here that k=2. In this case, as illustrated in FIG. 4, the condition of the first decision rule r₄ is satisfied, the condition of the second decision rule r₆ is not satisfied, and the decision rule of the third decision rule r₂ is satisfied. Thus, the determination is ended at this point. Then, the predicted values of the decision rules r₄ and r₆ whose conditions are satisfied are used to calculate a final prediction result.

In the example of FIG. 4, the final prediction result is an average value (75%) of “80%”, which is the predicted value of the decision rule r₄, and “70%”, which is the predicted value of the decision rule r₆. Validity of the above prediction result can be evaluated by comparison with a value of the label y shown in the training example set. Furthermore, by carrying out a similar process with respect to each of the training examples having “1” and a larger number of observation IDs, it is possible to evaluate prediction accuracy of the decision list with respect to the training example set as a whole.

Note that prediction with use of a decision list can be used both for prediction of a solution to a regression problem and for prediction of a solution to a classification problem. In the case of a decision list with use of which prediction of a solution to a regression problem is carried out, the output y is a real value as in the example of FIG. 3. In contrast, in the case of a decision list with use of which prediction of a solution to a classification problem is carried out, the output y is a probability vector indicative of a probability of belonging to each class of a classification destination.

By subjecting each of a plurality of decision lists to a such a process as described above for evaluating prediction accuracy of a decision list, it is possible to specify a decision list having highest prediction accuracy, and to determine, as the decision list to be output, the decision list having the highest prediction accuracy. This enables output of a decision list that is composed of simple rules and that also has high prediction performance.

Note here that in the machine learning method according to the present example embodiment, as illustrated in FIG. 3, three variables γ, Dᵢ, and θᵢ are introduced between a training example included in the training example set and a decision rule included in the decision rule set.

Though described in detail later, introduction of these variables enables an optimization problem of a decision list to be an integer linear programming problem (hereinafter referred to as integer linear programming (ILP). ILP can be efficiently and quickly solved with use of a known optimization solver, and an optimal decision list is determined by decoding a solution to ILP. Examples of an applicable optimization solver include Gurobi and CPLEX.

The present example embodiment also describes a process for generating a training example set from a set of decision trees. In the machine learning method according to the present example embodiment, it is not essential to generate a training example set from a set of decision trees. Furthermore, in the machine learning method according to the present example embodiment, not only a training example set generated from a set of decision trees, but also any training example set generated in any manner can be used.

### (Configuration of Information Processing Apparatus 4)

FIG. 5 is a block diagram illustrating example configuration of an information processing apparatus 4 according to the present example embodiment. The information processing apparatus 4 is an example of an information processing apparatus according to the present specification for determining a decision list to be output, and is an example of a prediction apparatus according to the present specification for carrying out prediction with use of a decision list which has been determined as the decision list to be output. As illustrated in FIG. 5, the information processing apparatus 4 includes a control section 40 that collectively controls sections of the information processing apparatus 4 and a storage section 41 that stores various kinds of data used by the information processing apparatus 4. The information processing apparatus 4 also includes an input section 43 that receives an input to the information processing apparatus 4 and an output section 44 that allows the information processing apparatus 4 to output data.

The control section 40 includes an acceptance section 401, a decision rule set generating section 402, a rank setting section 403, a prediction section 404, a list determining section 405, and an input data acquiring section 406. The storage section 41 stores a decision tree set 411, a decision rule set 412, a training example set 413, and a decision list 414.

The acceptance section 401 accepts setting of a value of a parameter k. The parameter k indicates the number of decision rules for use in calculation of a final prediction result. For example, the acceptance section 401 may accept, as a set value of the parameter k, the value of k, the value having been input via the input section 43.

The decision rule set generating section 402 generates a decision rule by extracting, from a decision tree included in the decision tree set 411 including at least one decision tree, each condition appearing on a path from a root to a leaf of the decision tree, and generates a decision rule set including the generated decision rule. In other words, the decision rule set generating section 402 generates a decision rule in which a value of a leaf (endpoint) of a decision tree is used as an output value y, and a value of each condition appearing on a path from a root to the leaf of the decision tree is used an input value x. Then, the decision rule set generating section 402 generates a decision rule set by carrying out the above process with respect to each of leaves (endpoints) of the decision tree. The decision rule set generating section 402 also stores, in the storage section 41, the generated decision rule set as the decision rule set 412.

Note that the decision rule set generating section 402 is not an essential component of the information processing apparatus 4. The decision rule set generating section 402 can alternatively be omitted. In this case, the information processing apparatus 4 uses the decision rule set 412 stored in advance to determine a decision list to be output.

The rank setting section 403 ranks decision rules included in the decision rule set 412. A method of ranking the decision rules will be described later.

The prediction section 404 calculates a prediction result with use of predicted values of k (k is a natural number of not less than 2) top-ranked decision rules which are among decision rules included in a decision list composed of a plurality of decision rules extracted from the decision rule set 412 and whose conditions are satisfied by a training example included in the training example set 413. In calculation of the prediction result, the prediction section 404 calculates the prediction result with use of k (k is a value accepted by the acceptance section 401) decision rules that are top-ranked by the rank setting section 403.

After the list determining section 405 determines a list to be output, and the storage section 41 stores the list as the decision list 414, the prediction section 404 uses the decision list 414 to carries out prediction.

For each of a plurality of decision lists generated from the decision rule set 412, the list determining section 405 determines, on the basis of a prediction result calculated for a training example included in the training example set 413, a decision list to be output. The decision list to be output is stored, as the decision list 414, in the storage section 41.

The input data acquiring section 406 acquires input data to be subjected to prediction with use of the decision list 414. Thus, the input data is data in a form similar to that of a training example used for learning of the decision list 414. For example, in a case where the decision list 414 is used that has been output by learning with use of a training example composed of a combination of an input x and an output y, the input data acquiring section 406 acquires input data indicative of a value of the input x.

The decision tree set 411 is a set of decision trees, the set including at least one decision tree. The decision rule set 412 is, as described earlier, a set including a plurality of decision rules that can be used to generate a decision list.

The training example set 413 is a set of a plurality of training examples for use in learning, i.e., determination of an optimal decision list. The training examples are each composed of the combination of the input x and the output y. The decision list 414 is a decision list that has been determined by the list determining section 405 to be output.

The present example embodiment assumes that k is set to a value of not less than 2. Note, however, that k can alternatively be set to 1.

The decision tree set 411 may also be a set of decision trees for use in a random forest. The random forest is a method in which a set of decision trees is generated from a training example, the decision trees included in the set are used to carry out prediction, and respective expectation results of the decision trees are integrated into a final prediction result. Thus, in a case where a decision rule set is generated from a set of decision trees for use in the random forest, and a prediction list generated from the decision rule set is used, it is possible to carry out prediction by a method similar to that of the random forest. This makes it possible to achieve high prediction performance as in the random forest.

### (Specific Example of Ranking)

As described above, in prediction with use of a decision list, decision rules are checked in order from higher to lower ranks so as to find k top-ranked decision rules whose conditions are satisfied, and a final prediction result is calculated from predicted values of the k top-ranked decision rules. It is therefore preferable to lower-rank, in the decision list, a more common decision rule that applies to a large number of examples, and to higher-rank, in the decision list, a special decision rule that applies only to a small number of examples.

Thus, for example, the rank setting section 403 may count the number of training examples that satisfy conditions of each of decision rules included in the decision rule set 412, and may rank the decision rules in ascending order of the number.

In the decision list, a decision rule with a highly reliable prediction result is desirably higher-ranked than a decision rule with an ambiguous prediction result.

Thus, in order to set a rank for a decision rule for predicting a solution to a regression problem, the rank setting section 403 may calculate, for a decision rule included in the decision rule set 412, a standard deviation of a predicted value (output y) of a training example that satisfies a condition of a the decision rule. The rank setting section 403 may rank decision rules in ascending order of the calculated standard deviation.

In order to set a rank for a decision rule for predicting a solution to a classification problem, the rank setting section 403 may carry out ranking on the basis of a difference between a predicted value about a training example that satisfies a condition of a decision rule and a predicted value to be compared.

The predicted value to be compared may be, for example, a predicted value of the default rule described earlier. In this case, the rank setting section 403 uses prediction of the default rule as a reference to rank decision rules in order in which prediction is successfully narrowed down than prediction of the default rule.

An indicator for evaluating whether prediction is successfully narrowed down may be, for example, a Kullback-Leibler (KL) divergence. In order to carry out ranking with use of the KL divergence, the rank setting section 403 calculates the KL divergence for a predicted value of the default rule and a predicted value of each of decision rules included in the decision rule set 412, and ranks the decision rules in descending order of a value of the KL divergence.

### (Optimization Problem of Decision List)

The prediction section 404 and the list determining section 405 solve an optimization problem of a decision list so as to determine a decision list to be output. As described in the overview, the optimization problem solved by the prediction section 404 and the list determining section 405 is ILP. The following description will discuss a method for allowing the optimization problem of the decision list to be ILP. In the following description, a decision list in which decision rules are ranked is also referred to as a “decision rule sequence”.

An optimization problem of a decision rule sequence R in which predicted values of k top-ranked decision rules whose conditions are satisfied are used to obtain a final prediction result can be defined as a problem for finding the decision rule sequence R that minimizes the following objective function. Note that A (a real number) is a normalization parameter. Note also that the decision rule sequence R is composed of decision rules included in a decision rule set Z.

$${f}_{opt \_ k} = {1}_{err} ( R , T ) + λ \vert R \vert$$

A training example can be represented by a pair (x,y) of the input x (x is a real number) and the output y. This allows a training example set T composed of n training examples to be represented as follows:

$$T = {\{ ( {x}_{i} , {y}_{i} ) \}}_{i = 1}^{n}$$

As described above, a decision list is also applicable to prediction of solutions to both a regression problem and a classification problem. In the case of a regression problem, y is a real value. In the case of a classification problem, y is a probability vector indicative of a probability of belonging to each class.

Note here that lₑᵣᵣ(R,T) is an error function with respect to prediction with use of the decision rule sequence R on the training example set T. λ|R| is a normalization term that gives a penalty to the decision rule sequence R which has a large size.

In the case of a regression problem, lₑᵣᵣ(R,T) may be, for example, a mean squared error (MSE), which is one of typical error functions. In the case of a classification problem, KL divergences between true values and predicted values output by a decision list may be calculated, and a sum of the KL divergences in an entirety of training examples may be used as an error function. A KL divergence is also referred to as an information gain.

The decision rule set Z is represented by the following formula:

$$Z = {\{ {z}_{{m}^{′}} \}}_{{m}^{′} = 1}^{\vert Z \vert}$$

Decision rules z_{m′} included in the decision rule set Z are ranked by the rank setting section 403 and are each assigned a subscript m′ in descending order of rank.

The decision rule sequence R in which decision rules are ranked is represented by the following formula:

$$R = {( {r}_{m} = ( {c}_{m} , {\hat{y}}_{m} ) )}_{m = 1}^{M}$$

where: M is the number of decision rules rₘ included in the decision rule sequence R; and m is a subscript indicative of a rank of a decision rule rₘ in the decision rule R. The decision rule rₘ is represented by a pair of a condition cₘ and a predicted value \hat{ }yₘ. Note that an expression “\hat{ }y” indicates a “hatted y”. The condition cₘ is a function that returns a true/false value to the input x. cₘ(x)=True indicates that the input x satisfies the condition cₘ.

The decision rule sequence R can also be defined as follows:

$$R = ( {l}_{1} , … , {l}_{M - k} , {\tilde{l}}_{1} , … , {\tilde{l}}_{k} )$$

In the decision rule sequence R,
\tilde{l}₁, . . . , \tilde{l}ₖ
are default rules and are all an identical default rule 1₀.

During prediction with use of the decision rule sequence R, with respect to the input x, 1=p→q∈R is viewed in order from higher to lower ranked decision rules in the decision rule sequence R, and an average value of respective postconditions q of k top-ranked decision rules in which x satisfies a condition p is output as a predicted value R(x). A decision rule 1 in which x satisfies the condition p in a k'th place in list order with respect to 1≤k′≤k is referred to as a k'th decision rule on the decision rule sequence R with respect to x.

Default rules included in a decision rule column R* subjected to optimization are given in advance, and k decision rules r_{|z|-k+1}, . . . , r_{|z|} in a given rule set Z={r₁, . . . , r_{|z|}} correspond to the default rules.

Note here that the following defines a covers function with respect to an mth decision rule rₘ=(cₘ,\hat{ }yₘ) in the decision rule sequence R, the input x, and an integer k (1≤k≤M).

$$covers ( {r}_{m} , x , k ) := ( {c}_{m} ( x ) ⋀ ‘ \vert A \vert = k ’ )$$

$$where$$

$$A = \{ {r}_{l} = ( {c}_{l} , {\hat{y}}_{l} ) \vert {c}_{l} ( x ) = True ; ∀ 1 \leq l \leq m \}$$

A decision rule in which covers(rₘ,x,k)=1 is called a kth decision rule with respect to x. With use of the covers function, a predicted value \hat{ }y=hR(x) in which the decision rule sequence R is used is given to the input x and an integer k(1≤k≤m) by the following:

$${h}_{R} ( x ) = \frac{1}{k} {\sum }_{m = 1}^{M} {\hat{y}}_{m} {\sum }_{{k}^{′} = 1}^{k} covers ( {r}_{m} , x , {k}^{′} )$$

The above formula shows that an average of decision rules which are among the decision rules included in the decision rule sequence R, whose conditions are satisfied, and which are given first to kth priority is regarded as a predicted value.

When the training example set T, a regularization parameter A, and the decision rule set Z are given, learning of a decision list according to the present example embodiment can be formulated as an optimization problem that outputs the rule sequence R* which satisfies the following under any error function L.

$$\text{?} = \text{?} L ( {h}_{R} ( {x}_{i} ) , {t}_{i} ) + λ M \qquad ( 1 )$$

$$\text{?} \text{indicates text missing or illegible when filed}$$

In Formula (1), tᵢ is a one-hot vector corresponding to a label tᵢ.

Note here that the following variables are introduced so that ILP transformation is carried out.

γ is a binary vector having a size |Z|. The binary vector γ indicates which of the decision rules included in the decision rule set Z is included in the decision rule sequence R. The binary vector γ that has an m'th element y_{m′} of 1 means that the decision rules z_{m′} are included in the decision rule sequence R. In other words, a variable indicative of a decision list includes a variable γ_{m′} indicating whether each of the decision rules included in the decision rule set Z is included in the decision rule sequence R.

Assume that an order of the decision rules in the decision rule sequence R matches an order in the decision rule set Z. Under such a constraint, a problem for finding the optimal decision rule sequence R is equivalent to a problem for finding the optimal γ.

sᵢ is a total number of decision rules satisfied by an ith input xᵢ in the decision rules included in the decision rule set Z.

bi is a sequence of subscripts m′ of the decision rules satisfied by the ith input xᵢ in the decision rules included in the decision rule set Z.

$${b}_{i} = {( {b}_{ij} )}_{j = 1}^{{s}_{i}}$$

Each element bᵢⱼ indicates that a jth decision rule satisfied by the input xᵢ on the decision rule set Z is z_{bij}. Note here that bi is also referred to as a “satisfied rule list” with respect to the input xᵢ. The satisfied rule list bi is present for each input xᵢ.

Dᵢ is a binary variable vector. The binary variable vector Dᵢ is a binary variable indicative of a decision rule for use in prediction of the input xᵢ. The binary variable vector Dᵢ is represented by the following formula:

$${D}_{i} = {( {D}_{ij} )}_{j = 1}^{{s}_{i}}$$

When a decision rule z_{bij} is used for prediction of the input xᵢ, an element Dᵢⱼ=1. Otherwise, the element Dᵢⱼ=0. In other words, a variable indicative of a decision list includes a variable indicating whether a decision rule whose condition is satisfied by the input xᵢ (training example) is used for prediction about the input xᵢ.

θᵢ is a threshold with respect to a position on the satisfied rule list bi. The threshold θᵢ is used to indicate that a decision rule whose rank in the satisfied rule list bi is at or higher than the threshold θᵢ and which is included in the decision list R is used for prediction.

Use of the above-defined variables γ, Dᵢ, and θᵢ makes it possible to represent, by the following constraint formulas (3) to (5), a condition that “a decision rule whose priority in the satisfied rule list bi is at or higher than the threshold θᵢ and which is included in the decision list R is used for prediction about the input xᵢ, and other decision rule(s) is/are not used for prediction about the input xᵢ”.

$${D}_{ij} > 0 \qquad ( 3 )$$

$$if$$

$$j \leq {θ}_{i}$$

$$and$$

$$\text{?} > 0$$

$${D}_{ij} < 1 \qquad ( 4 )$$

$$if$$

$$j \leq {θ}_{i}$$

$$and$$

$$\text{?} < 1$$

$${D}_{ij} < 1 \qquad ( 5 )$$

$$if$$

$$j > {θ}_{i}$$

$$\text{?} \text{indicates text missing or illegible when filed}$$

Constraints represented by Formulas (3) to (5) are equivalent to the following Inequities (6) to (8).

$$\vert Z \vert ( {D}_{ij} + 1 - \text{?} ) + ( j - {θ}_{i} ) > 0 \qquad ( 6 )$$

$$\vert Z \vert ( 1 - {D}_{ij} + \text{?} ) + ( j - {θ}_{i} ) > 0 \qquad ( 7 )$$

$$\vert Z \vert ( 1 - {D}_{ij} ) + ( {θ}_{i} - j + 1 ) > 0 \qquad ( 8 )$$

$$\text{?} \text{indicates text missing or illegible when filed}$$

The following Inequality (9) is also given so as to ensure that k rules are used to predict each case.

$$\text{?} {D}_{ij} = k ; \qquad ( 9 )$$

$$∀ 1 \leq i \leq n$$

$$\text{?} \text{indicates text missing or illegible when filed}$$

Under constraints represented by the above Formulas (6) to (9), an objective function corresponding to Formula (1) is given by the following formula:

$$\text{?} \frac{1}{k} ( \text{?} {D}_{ij} L ( \text{?} , {t}_{i} ) ) + λ {\sum }_{{m}^{′} = 1}^{\vert Z \vert} {γ}_{{m}^{′}} \qquad ( 10 )$$

$$\text{?} \text{indicates text missing or illegible when filed}$$

The first term in Formula (10) is an error term corresponding to a prediction error in the objective function used for the optimization problem of the decision rule sequence R (described earlier). The second term in Formula (10) corresponds to the second term in the foregoing objective function: f_{opt_k}=lₑᵣᵣ(R,T)+λ|R|, and is a normalization term that gives a penalty to the decision rule sequence R having a large size. Note that the normalization term is not limited to that shown in Formula (10) and may be, for example, a normalization term which gives a larger penalty value as more conditions are included in decision rules included in a decision list.

The optimal γ is found by solving the above ILP problem. In a case where the optimal γ is found, the optimized decision rule column R* can be obtained by arranging, in the same order as the order in the decision rule set Z, only decision rules z_{m′} in which γ_{m′}=1.

### (Method for Determining Decision List to be Output)

The prediction section 404 and the list determining section 405 use the above Formulas (6) to (9) to search for the variables γ_{m′}, θᵢ, and Dᵢⱼ at a time when a value of the objective function represented by Formula (10) satisfies a predetermined condition. Note that these variables allow indication of a position in a decision list at which position a decision rule included in a decision rule set is located. The predetermined condition is a condition for determining whether to end optimization, and is determined in advance.

Specifically, first, the list determining section 405 sets each of the foregoing variables to an initial value. The prediction section 404 calculates the value of the objective function with use of a decision list represented by each of those variables. In a case where the calculated value does not satisfy the predetermined condition, the list determining section 405 updates the foregoing variables. Until the predetermined condition is satisfied, the prediction section 404 and the list determining section 405 repeatedly update the variables and repeatedly calculate the value of the objective function. Thus, a value of each of the variables, the value indicating an optimal decision list, is specified.

### (Flow of Machine Learning Method)

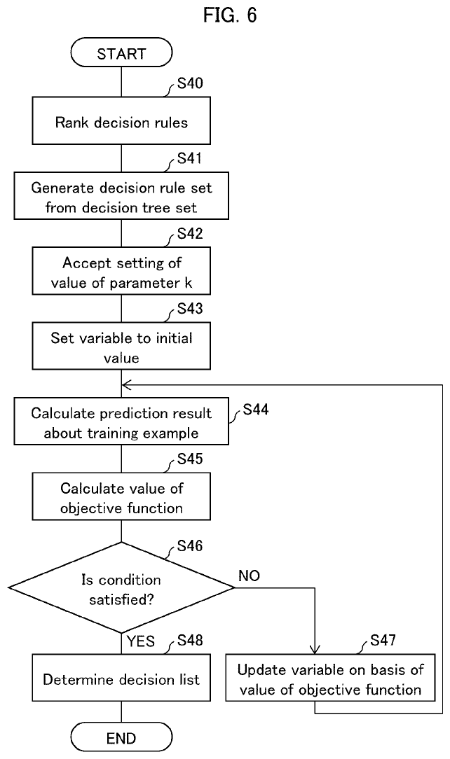

The following description will discuss, with reference to FIG. 6, a flow of a machine learning method carried out by the information processing apparatus 4. FIG. 6 is a flowchart showing the flow of the machine learning method carried out by the information processing apparatus 4.

In S40, the rank setting section 403 ranks the decision rules included in the decision rule set 412.

In S41, the decision rule set generating section 402 generates a decision rule set from the decision tree set 411. The decision rule set generating section 402 stores, in the storage section 41, the generated decision rule set as the decision rule set 412.

Note that the decision tree set 411 may be generated by a random forest as described earlier. In this case, the information processing apparatus 4 may carry out, in advance of S41, a process for generating the decision tree set by the random forest.

In S42, the acceptance section 401 accepts setting of the value of the parameter k. A user of the information processing apparatus 4 can input a desired value of the parameter k via, for example, the input section 43. The acceptance section 401 sets, to the value of the parameter k, the value thus input.

In S43, the list determining section 405 sets each of various variables to an initial value. Specifically, the list determining section 405 sets, to the initial value, each of values of the foregoing three variables, i.e., γ, θᵢ, and Dᵢ.

In S44, the prediction section 404 calculates, with use of the variables each of which has been set to the initial value in S43, a prediction result about a training example included in the training example set 413. The prediction result is calculated with use of predicted values of k top-ranked decision rules which are among a plurality of decision rules included in a decision list represented with use of each of the above variables and whose conditions are satisfied by the training example.

In S45, the list determining section 405 calculates a value of an objective function with use of the prediction result calculated in S44. Specifically, the list determining section 405 calculates a value of Formula (10) (described earlier), which represents the objective function.

In S46, the list determining section 405 determines whether a result of calculation in S45 satisfies a predetermined condition. In a case where the result is determined in S46 to be YES, the process proceeds to S48. In contrast, in a case where the result is determined in S46 to be NO, the process proceeds to S47.

In S47, the list determining section 405 updates the values of the foregoing three variables on the basis of the value of the objective function, the value having been calculated in S45. The variables only need to be updated by a method that enables the value of the objective function to change in a direction in which the predetermined condition is satisfied. Thereafter, the process returns to S44.

In S48, the list determining section 405 determines, as a decision list to be output, a decision list specified by the values of the three variables at a time when it is determined in S46 that the condition is satisfied. This enables output of a decision list that is composed of simple decision rules and that also has high prediction performance. The list determining section 405 stores the determined decision list, as the decision list 414, in the storage section 41. This ends the process of FIG. 6.

In the above-described process, the variables are updated in S47, so that a decision list specified by the variables is updated. For the updated decision list, the prediction result is calculated in S44. This makes it possible to say that in S48, for each of a plurality of decision lists generated from the decision rule set, a decision list to be output is determined on the basis of a prediction result calculated for a training example included in the training example set. The above-described process (in particular, S43 to S48) can alternatively be carried out by an optimization solver.

### (Flow of Prediction Method)

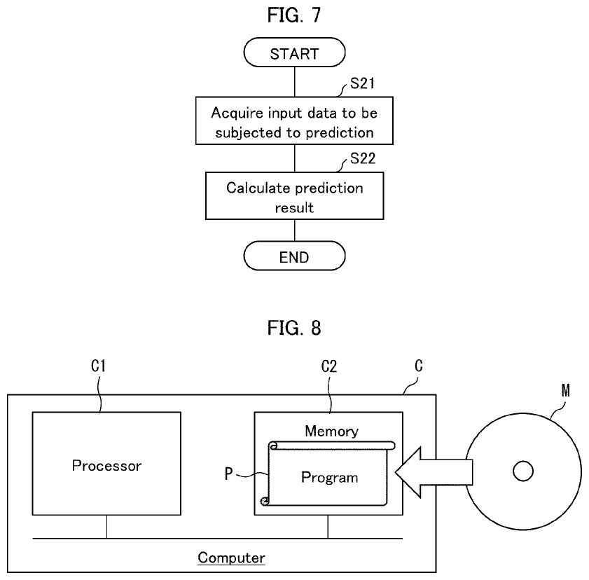

Next, the following description will discuss a flow of a prediction method according to the present example embodiment with reference to FIG. 7. Note that steps of the prediction method of FIG. 7 may be carried out by a processor of the information processing apparatus 4 or by a processor of another apparatus. Alternatively, the steps may be carried out by processors provided in respective different apparatuses.

In S21, the input data acquiring section 406 acquires input data to be subjected to prediction. In S22, the prediction section 404 calculates predicted values of k top-ranked decision rules which are among decision rules included in the decision list 414 and whose conditions are satisfied by the input data acquired in S21, and uses the predicted values to calculate a prediction result.

As described above, a configuration is employed such that in the information processing apparatus 4 according to the present example embodiment, a variable indicative of the decision list includes a variable indicating whether each of decision rules whose conditions are satisfied by the training example is used for prediction about the training example by the prediction section n 404. Thus, according to the information processing apparatus 4 according to the present example embodiment, not variables the number of which is the number of decision rules included in a decision list but variables the number of which is the number of decision rules whose conditions are satisfied by a training example are used to carry out optimization calculation. This makes it possible to reduce the number of variables and prevent an increase in processing time and/or memory used amount that is/are necessary for determination of a decision list.

A configuration is employed such that in the information processing apparatus 4 according to the present example embodiment, the variable indicative of the decision list includes a variable indicating whether the decision list includes decision rules that are included in a decision rule set, which is a set of decision rules. Thus, according to the information processing apparatus 4 according to the present example embodiment, not variables the number of which is the number of decision rules included in a decision list but variables the number of which is the number of decision rules whose conditions are satisfied by a training example are used to carry out optimization calculation. This makes it possible to reduce the number of variables and prevent an increase in processing time and/or memory used amount that is/are necessary for determination of a decision list.

The information processing apparatus 4 according to the present example embodiment further includes the acceptance section 401 that accepts setting of a value of the k, the prediction section 404 calculating the prediction result with use of the value of the k, the value having been accepted by the acceptance section 401.

The above configuration brings about an effect such that the user who sets a value of k to a desired value can determine a decision list which is suitable to calculate a prediction result with use of the value of k. Thus, for example, the user who wishes to attach great importance to prediction performance can set k to a great value, and the user who wishes to attach great importance to explainability of a prediction result can set k to a small value. That is, the above configuration enables the user to freely select a tradeoff between prediction performance and explainability.

The present example embodiment assumes that k is set to a value of not less than 2. Note, however, that k can alternatively be set to 1. Note also that the acceptance section 401 may be employed also in the above-described first example embodiment and configured to accept setting of the value of k.

The information processing apparatus 4 according to the present example embodiment also includes: the input data acquiring section 406 that acquires input data to be subjected to prediction; and the prediction section 404 that calculates a prediction result with use of predicted values of k top-ranked decision rules which are among the decision rules included in the decision list determined by the list determining section 405 and whose conditions are satisfied by the input data (to be precise, k predicted values corresponding to respective k top-ranked decision rules whose conditions are satisfied).

According to the above configuration, without an increase in processing time and/or memory used amount that is/are necessary for determination of a decision list to be used for prediction, it is possible to determine a decision list and carry out prediction.

### Third Example Embodiment

The following description will discuss a third example embodiment of the present invention in detail with reference to the drawings. Note that members having functions identical to those of the respective members described in the second example embodiment are given respective identical reference numerals, and a description of those members is not repeated.

### (Overview of System)

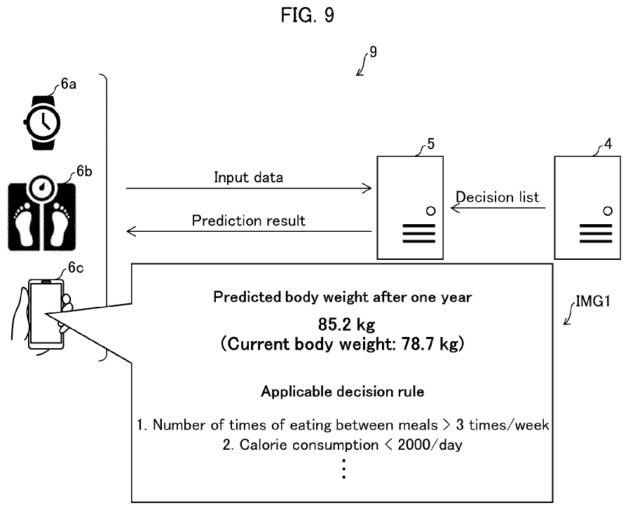

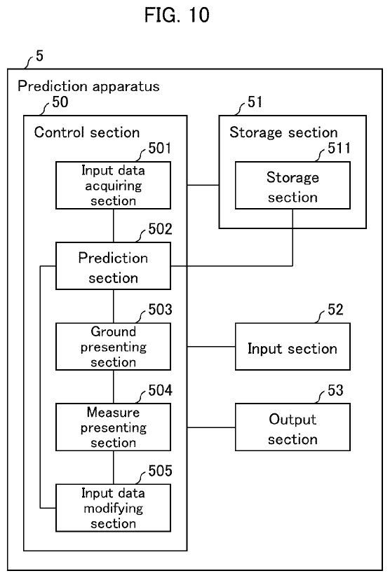

FIG. 9 is a diagram illustrating an overview of an information processing system 9 according to the present example embodiment. As illustrated in FIG. 9, the information processing system 9 includes not only the information processing apparatus 4 described in the second example embodiment but also a prediction apparatus 5, a smart watch 6a, a body weight scale 6b, and a terminal apparatus 6c.

FIG. 9 illustrates only one user (a user having the terminal apparatus 6c). Note, however, that the information processing system 9 is available to a plurality of users. It is possible to request, in advance, each user using the information processing system 9 to carry out user registration. This enables the information processing system 9 to collect and manage information pertaining to each user, so that services in accordance with individual users can be provided.

The prediction apparatus 5 carries out prediction with use of a decision list which has been determined by the information processing apparatus 4. The present example embodiment discusses an example in which the prediction apparatus 5 carries out prediction related to healthcare. In a case where prediction related to healthcare is carried out, the information processing apparatus 4 only needs to generate a decision rule with use of a training example set including various kinds of data related to healthcare, and generate a decision list including the generated decision rule. Note that “prediction” as used herein includes not only prediction of a future event but also prediction of a classification to which a target will belong to (i.e., classification of a target).

For example, it is possible to generate a decision list for predicting body weight after one year. In this case, it is only necessary to use a training example set including (i) various kinds of data relevant to body weight and (ii) body weight after one year from when the data was measured. Examples of the data relevant to body weight include attribute data indicative of attributes such as age and gender, and measurement data obtained by measuring, for example, body weight, height, an amount of exercise, and calorie intake at the time of prediction. Examples of the data relevant to body weight may include not only the above-listed data but also data indicative of health conditions, such as results of a medical checkup and various examinations (e.g., a cholesterol level and a blood sugar level), and vital data such as a pulse, body temperature, and blood pressure.

A user of the information processing system 9 uses, for example, the smart watch 6a, the body weight scale 6b, and the terminal apparatus 6c, which are used by the user, to collect various kinds of data necessary for the prediction and input the collected data, as input data, to the prediction apparatus 5. The input data only needs to be input to the prediction apparatus 5 via, for example, a communication network.

For example, by using the smart watch 6a, the user can measure, for example, the number of steps, exercise time, sleeping hours, a heart rate, and/or calorie consumption of the user, and use these pieces of data as the input data for use in the prediction. Alternatively, by using the body weight scale 6b, the user can measure, for example, body weight, a body fat percentage, and/or a body mass index (BMI) of the user, and use these pieces of data as the input data for use in the prediction. Further alternatively, the user can input, to the terminal apparatus 6c, age, gender, height, and/or a result of, for example, a medical checkup of the user, and use those pieces of data as the input data. Note that an apparatus used to collect the input data is not limited to the above-described example. For example, it is possible to use a wearable terminal different from a smart watch, and/or various pieces of inspection equipment to collect input data. It is also possible to use, for example, a desktop computer to collect the input data.

Data collected by various apparatuses are collected in a predetermined apparatus such as the terminal apparatus 6c and transmitted to the prediction apparatus 5 via the predetermined apparatus. The data collected by the various apparatuses may be individually transmitted to the prediction apparatus 5. For example, the data measured with use of the smart watch 6a may be transmitted from the smart watch 6a to the prediction apparatus 5, and the data measured with use of the body weight scale 6b may be transmitted from the body weight scale 6b to the prediction apparatus 5. In this case, the prediction apparatus 5 may store the received data as data of a corresponding user and read the data during prediction about the user.

The prediction apparatus 5 that has acquired the input data as described above carries out prediction with use of the acquired input data and the decision list acquired from the information processing apparatus 4. More specifically, the prediction apparatus 5 calculates a prediction result with use of predicted values of k (k is a natural number of not less than 2) top-ranked decision rules which are among decision rules included in the decision list and whose conditions are satisfied by the input data.

The user can check the prediction result via, for example, the terminal apparatus 6c. In this case, the prediction apparatus 5 notifies the terminal apparatus 6c of the prediction result. A manner in which the prediction result is presented to the user is not particularly limited. For example, as illustrated in FIG. 9, the prediction apparatus 5 may present the prediction result by displaying, in, for example, a display apparatus included in the terminal apparatus 6c, an image indicative of the prediction result.

IMG1 illustrated in FIG. 9 is an example of an image for providing notification of the prediction result. IMG1 shows predicted body weight after one year of the user and decision rules whose conditions are satisfied by the input data. Specifically, IMG1 displays a decision rule that the number of times of eating between meals is more than 3 per week and a decision rule that daily calorie consumption is less than 2,000 kcal. These decision rules are some of the k top-ranked decision rules whose conditions are satisfied by the input data, and can be said to be ground for the prediction result.

Thus, the information processing system 9 according to the present example embodiment includes the information processing apparatus 4 that determines a decision list, the prediction apparatus 5 that carries out prediction with use of the decision list which has been determined by the information processing apparatus 4, and the terminal apparatus 6c that outputs the prediction result calculated by the prediction apparatus 5. Furthermore, to the user, the prediction apparatus 5 presents, as ground for the prediction result, some or all of the k top-ranked decision rules used to calculate the prediction result. This makes it possible to give the user a material for determining validity of the prediction result.

The presented decision rules whose conditions have been satisfied is one of major factors in successful obtainment of the presented prediction result. Thus, presentation of the decision rules makes it possible to give the user a great clue for improving the prediction result. For example, in the example of FIG. 9, predicted body weight of the user has a greater value than the current body weight, and the decision rule is displayed that the number of times of eating between meals is more than 3 per week. From these, the user can understand that setting the number of times of eating between meals to not more than 3 per week results in failure to satisfy the condition of the first decision rule, so that the prediction result of body weight will be improved. Similarly, the user can understand that setting daily calorie consumption to not less than 2,000 kcal so as to prevent satisfaction of the decision rule that daily calorie consumption is less than 2,000 kcal will improve the prediction result of body weight.

As described in the second example embodiment, specifically, for a training example included in a training example set, the information processing apparatus 4 calculates a prediction result on the basis of predicted values of k top-ranked decision rules which are among decision rules included in a decision list and whose conditions are satisfied by the training example, and by repeatedly carrying out, until a predetermined condition is satisfied by a value of an objective function including an error term indicative of an error of the prediction result, a process for updating a variable indicative of the decision list, the information processing apparatus 4 determines the decision list to be output. The variable includes a variable indicative of a decision rule which is among the decision rules whose conditions are satisfied and which is given kth priority to be used for prediction.

### (Configuration of Prediction Apparatus 5)

FIG. 10 is a block diagram illustrating an example configuration of the prediction apparatus 5 according to the present example embodiment. As illustrated in FIG. 10, the prediction apparatus 5 includes a control section 50 that collectively controls sections of the information processing apparatus 5 and a storage section 51 that stores various kinds of data used by the information processing apparatus 5. The prediction apparatus 5 also includes an input section 52 that receives an input to the prediction apparatus 5 and an output section 53 that allows the prediction apparatus 5 to output data. The prediction apparatus 5 can acquire data from an external apparatus(es) such as the information processing apparatus 4 and/or the terminal apparatus 6c via the input section 52, and can transmit data to, for example, the information processing apparatus 4 via the output section 53. Note that it is possible to provide a communication section in addition to the input section 52 and the output section 53 so as to transmit and receive data to and from the external apparatus(es) via the communication section.

The control section 50 includes an input data acquiring section 501, a prediction section 502, a ground presenting section 503, a measure presenting section 504, and an input data modifying section 505. The storage section 51 stores a decision list 511.

As in the case of the input data acquiring section 406 of the second example embodiment, the input data acquiring section 501 acquires input data to be subjected to prediction with use of the decision list 511. The decision list 511 includes a plurality of decision rules as in the case of the decision list 414 described in the second example embodiment. A method for determining the decision list 511 is similar to the method, described in the second example embodiment, for determining the decision list 414. For example, the decision list generated by the information processing apparatus 4 may be stored, as the decision list 511, in the storage section 51 of 5 of the prediction apparatus.

As in the case of the prediction section 404 of the second example embodiment, the prediction section 502 calculates a prediction result with use of the decision list 511 and the input data acquired by the input data acquiring section 501. More specifically, the prediction section 502 specifies k top-ranked decision rules which are among decision rules included in the decision list 511 and whose conditions are satisfied by the input data, and calculates a prediction result with use of predicted values of the specified decision rules.

The ground presenting section 503 presents, as ground for the prediction result, some or all of the k top-ranked decision rules used by the prediction section 502 to calculate the prediction result. This brings about an effect of making it possible to give the user a material for determining validity of the prediction result. A presentation manner is not particularly limited. For example, as in the example of FIG. 9, the ground presenting section 503 may present the decision rules by displaying the decision rules in the terminal apparatus 6c of the user. Alternatively, the ground presenting section 503 may present the decision rules in the form of a voice output or a printed output. The presentation manner that is not particularly limited also applies to presentation of the prediction result calculated by the prediction section 502, and to presentation of a measure by the measure presenting section 504 (described later).

For some or all of the k top-ranked decision rules used to calculate the prediction result, the measure presenting section 504 presents, as support information for supporting decision making by a user, a measure for improving the prediction result. This makes it possible to clearly indicate what to do in order to improve the prediction result, and thus brings about an effect of effectively supporting decision making by a user.

The input data modifying section 505 reflects, in the input data, an effect of the measure presented by the measure presenting section 504. In other words, assuming that the measure has been carried out, the input data modifying section 505 reflects, in the input data, an influence of the measure. Assume, for example, that the input data includes the current average activity level of the user and that the measure presented by the measure presenting section 504 is to increase the average activity level by 10%. In this case, the input data modifying section 505 makes a modification to increase, by 10%, the average activity level of the user in the input data.

In a case where the input data modifying section 505 reflects the effect of the measure in the input data, the prediction section 502 calculates, with use of the input data in which the effect of the measure is reflected, a prediction result obtained by carrying out the measure. The measure presenting section 504 presents not only the measure but also the prediction result obtained by carrying out the measure. This enables the user to understand the effect obtained by carrying out the measure.

### (Display Example)

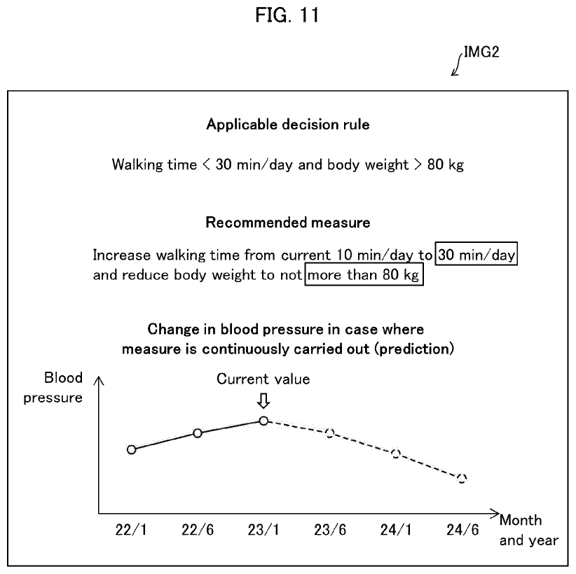

FIG. 11 is an example display screen in which a decision rule, a measure, and a prediction result are displayed. IMG2 illustrated in FIG. 11 shows a decision rule whose condition is satisfied by input data of a user, and also shows a recommended measure and prediction of a change in blood pressure in a case where the user continuously carries out the measure. That is, this example assumes use of the decision list 511 for predicting future blood pressure of the user. Input data of the decision list 511 as described above only needs to be various kinds of data related to blood pressure of the user.

The decision rule shown in IMG2 is a decision rule that walking time is less than 30 minutes per day and body weight is more than 80 kg. That is, in this example, daily walking time of the user is less than 30 minutes, and body weight of the user is more than 80 kg. Then, input data indicative of the above walking time and the above body weight is input to the prediction apparatus 5 and used to predict blood pressure of the user.

IMG2 also shows a text indicative of the recommended measure, the text saying “INCREASE WALKING TIME FROM CURRENT 10 MIN/DAY TO 30 MIN/DAY AND REDUCE BODY WEIGHT TO NOT MORE THAN 80 KG”. The measure presenting section 504 can generate such a text with use of the decision rule and the input data, and present the text to the user.

For example, for each of decision rules included in the decision list 511, a template having a blank part to which a value of the input data is to be input may be prepared in advance. This enables the measure presenting section 504 to input a value of input data to a template in accordance with a decision rule and generate a text indicative of the recommended measure. For example, the text shown in IMG2 makes it possible to generate a text indicative of the recommended measure by inputting, to an “XX” part of a template “increase walking time from the current XX min/day to 30 min/day and reduce body weight to not more than 80 kg”, user's walking time extracted from the input data.

In the example of FIG. 11, the condition of the decision rule is not satisfied in the case of achievement of one of the following: the walking time reaching not less than 30 minutes per day; and the body weight reaching not more than 80 kg. It is therefore only necessary to present a measure for achieving one of the above. That is, the measure presented by the measure presenting section 504 may be generated on the basis of all of the decision rules or may be generated on the basis of some of the decision rules.

The measure may be generated in advance for each of the decision rules included in the decision list 511, and may be stored in, for example, the storage section 51. Furthermore, the measure presenting section 504 may generate the measure.

For example, the measure presenting section 504 may accept an input of a goal that is set for the prediction result by the user, and may generate a measure for achieving the goal. Assume, for example, that the user has input a goal of making blood pressure in a normal range within a half year. In this case, the measure presenting section 504 only needs to generate the measure in accordance with an extent of a gap between the current blood pressure and the normal range and a designated period that is not more than a half year.

Furthermore, for example, the measure presenting section 504 may generate the measure with use of a language model that has been trained to generate an answer to an input sentence. In this case, the measure presenting section 504 only needs to input a decision rule to the language model and instruct the language model to answer a measure for preventing the decision rule from being satisfied.

IMG2 also shows, by a line graph, prediction of the change in blood pressure in a case where the user continuously carries out the measure. The line graph also shows a change in blood pressure from one year ago to the present.

The current value of blood pressure is shown in input data input by the user (or acquired from an apparatus having a function to measure blood pressure, such as the smart watch 6a). Thus, the prediction section 502 can acquire the current value of blood pressure from the input data. A past blood pressure value that was input by the user in the past may be stored in, for example, the storage section 51. Alternatively, a past blood pressure value may be input by the user. Further alternatively, a past blood pressure value may be acquired from an apparatus (e.g., the smart watch 6a) used by the user to measure blood pressure.

The prediction section 502 calculates a predicted value of blood pressure. Blood pressure measured every half year is displayed in the example of IMG2. Thus, the prediction section 502 may predict blood pressure after a half year with use of (i) the decision list 511 that has been trained to predict blood pressure after a half year and (ii) input data in which the effect of the measure has been reflected by the input data modifying section 505. The input data modifying section 505 may further modify the input data on the basis of the predicted value of blood pressure after a half year and the measure, and the prediction section 502 may use the modified input data to predict blood pressure after another half year (i.e., after one year from the present). Thus, by repeatedly carrying out modification of the input data and prediction with use of the modified input data, it is possible to predict a change in blood pressure in a case where the user continuously carries out the measure.

Assume, for example, that the current blood pressure (systolic blood pressure) of the user is 150, and blood pressure after a half year is 155, the blood pressure being predicted by the prediction section 502 by using, as some of the input data, the above blood pressure value (i.e., 150), the walking time, and the body weight. In this case, on the basis of details of the recommended measure, the input data modifying section 505 makes a modification to replace the walking time in the input data used for the above-described prediction with 30 min/day and replace the body weight in the input data used for the above-described prediction with not more than 80 kg (for example, 78 kg). The prediction section 502 uses the modified input data to repredict blood pressure after a half year (in June 2023).

Subsequently, the input data modifying section 505 further modifies the input data used for reprediction of blood pressure in June 2023, and generates input data for use in prediction of blood pressure in January 2024. Specifically, the input data modifying section 505 makes a modification to replace the current value of blood pressure in the input data with a value calculated by reprediction. In a case where the input data includes data that changes over time, such as age of the user, the input data modifying section 505 may also modify such data. The prediction section 502 uses the modified input data to predict blood pressure after another half year (in January 2024). By repeatedly carrying out such a process, it is possible to predict a change in blood pressure in a case where the measure is continuously carried out.

Note that data to be subjected to modification can include not only data that changes in a relatively short period of time, such as daily amount of exercise but also data that is less likely to change in a short period of time, such as body weight. Thus, the input data modifying section 505 may reflect, in modification, a pattern of change in data. For example, the input data modifying section 505 may use a body weight change model obtained by modeling a change in pattern of body weight to predict future body weight from the current body weight of the user and make a modification to replace a value of body weight in the input data with a predicted value. In the example of IMG2, the input data modifying section 505 only needs to predict body weight measured every half year (body weight in June 2023 and January 2024), and reflect, in input data for use in prediction carried out every half year (input data for use in prediction of blood pressure in January 2024 and input data for use in prediction of blood pressure in June 2024), a predicted value obtained from prediction of the body weight.

The prediction section 502 may display not only a graph showing a change in blood pressure in a case where the measure is carried out but also a graph showing a change in blood pressure in a case where the measure is not carried out. As in the case of the change in blood pressure in a case where the measure is carried out, the change in blood pressure in a case where the measure is not carried out can also be predicted by repeatedly carrying out modification of the input data by the input data modifying section 505 and prediction by the prediction section 502 with use of the modified input data.

### (Flow of Process)

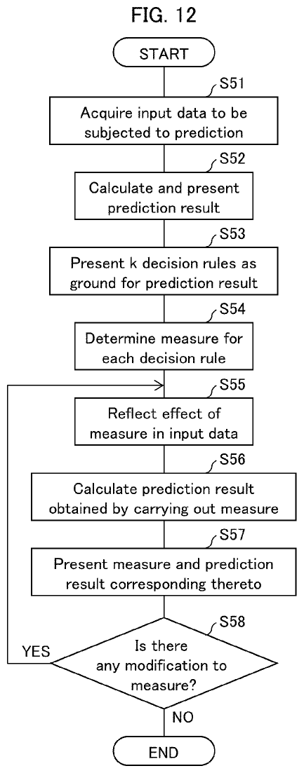

Next, the following description will discuss, with reference to FIG. 12, a flow of a process carried out by the prediction apparatus 5 according to the present example embodiment. FIG. 12 is a flowchart showing the flow of the process carried out by the prediction apparatus 5. Note that steps of the prediction method of FIG. 12 may be carried out by a processor of the prediction apparatus 5 or by a processor of another apparatus. Alternatively, the steps may be carried out by processors provided in respective different apparatuses.

In S51, the input data acquiring section 501 acquires input data to be subjected to prediction. For example, the input data acquiring section 501 may acquire input data from at least one selected from the group consisting of the smart watch 6a, the body weight scale 6b, and the terminal apparatus 6c, which are illustrated in FIG. 9.

In S52, the prediction section 502 calculates predicted values of k top-ranked decision rules which are among decision rules included in the decision list 511 and whose conditions are satisfied by the input data acquired in S51, and uses the predicted values to calculate a prediction result. The prediction section 502 presents the calculated prediction result to the user. For example, the prediction section 502 may display the calculated prediction result in the terminal apparatus 6c.

In S53, the ground presenting section 503 presents, as ground for the prediction result, the k top-ranked decision rules used to calculate the prediction result in S52. Note that the ground presenting section 503 may present all of the k top-ranked decision rules or may present some of the k top-ranked decision rules (for example, a predetermined number of top-ranked decision rules among the k top-ranked decision rules). Note also that the decision rules are presented in response to any trigger and in any manner. For example, the ground presenting section 503 may present the decision rules together with the prediction result when the prediction section 502 presents the prediction result. Alternatively, for example, the ground presenting section 503 may display the decision rules, after the prediction section 502 presents the prediction result, in response to the fact that a predetermined operation for displaying ground for prediction has been carried out. The ground presenting section 503 may display, as they are, the decision rules included in the decision list 511, or may display the decision rules by processing the decision rules so as to allow the user to easily understand details of the decision rules (for example, by replacing a sign such as a sign of inequality with “not less than” or “not more than”.

In S54, the measure presenting section 504 determines, for each of the decision rules presented in S53, a measure for improving the prediction result calculated in S52. More specifically, the measure presenting section 504 determines a measure for preventing satisfaction of conditions specified in the decision rules. Note that the number of decision rules presented in S53 may be one. In this case, a measure for the one decision rule is determined in S54.

In S55, the input data modifying section 505 reflects, in the input data acquired in S51, an effect of the measure determined in S54. As described earlier, a method for reflecting the effect of the measure in the input data only needs to be determined in advance. Subsequently, in S56, the prediction section 502 calculates, with use of the input data in which the effect of the measure is reflected, a prediction result obtained by carrying out the measure.

In S57, the measure presenting section 504 presents, as support information for supporting decision making by the user, the measure determined in S54, and presents the prediction result calculated in S55, that is, the prediction result obtained by carrying out the measure. Note that timing of presentation of each piece of information is not limited to this example. For example, the measure presenting section 504 may present a measure first, and then present a prediction result obtained by carrying out the measure in response to the fact that for example, an operation by the user has been carried out. Alternatively, during presentation of the prediction result calculated in S52, the measure presenting section 504 may present a measure and a prediction result obtained by carrying out the measure. The ground presenting section 503 may present a decision rule at this time. That is, the prediction result, the decision rule, the measure, and the prediction result obtained by carrying out the measure may be presented simultaneously.

In S58, the measure presenting section 504 determines whether the measure presented in S57 will be modified. For example, upon acceptance of an operation carried out by the user to modify the measure, the measure presenting section 504 may determine that the measure will be modified. It is arbitrary what operation the operation to modify the measure should be. For example, in the example of IMG2 illustrated in FIG. 11, “30 MIN/DAY” and “80 KG” parts may be capable of being modified by the user. It turns out in this case that the operation to modify the measure is an operation to select the parts and rewrite numerical values.

In a case where a result of determination in S58 is YES, the measure presenting section 504 modifies the measure presented in S57, and then the process returns to S55. In S55, to which the process has transitioned from S58, the input data modifying section 505 reflects an effect of the modified measure in the input data. By the process in S56 and S57, the process being carried out after S55, the modified measure and a prediction result corresponding to the modified measure are presented to the user. In contrast, in a case where the result of determination in S58 is NO, the process of FIG. 12 is ended.

Thus, the measure presenting section 504 may accept modification of the presented measure. In this case, the prediction section 502 calculates, with use of the input data in which an effect of the modified measure is reflected, a prediction result obtained by carrying out the measure. The measure presenting section 504 presents not only the modified measure but also the prediction result obtained by carrying out the measure. This enables the user to arrange the measure while checking the prediction result.

Furthermore, after the presented measure is carried out, the measure presenting section 504 may accept feedback from the user on the measure. This enables the measure presenting section 504 to reflect the feedback in future determinations of measures. Assume, for example, that feedback from some of a plurality of users to which the measure presenting section 504 has presented measures for increasing daily walking time indicates that it is difficult to continuously carry out the measure. Assume also that all the measures recommended to some of the users were measures for increasing walking time to not less than 1.5 times the current walking time. In this case, during future presentation of a measure for increasing the walking time, the measure presenting section 504 may set recommended walking time to walking time that is not more than 1.5 times the current walking time. This makes it possible to present a measure that is easy for a user to continuously carry out.

### Other Application Examples

As described above, the information processing system 9 is applicable to prediction related to healthcare. The information processing system 9 is applicable not only to the above but also to, for example, prediction of a training menu, a meal menu, or a supplement that is recommended to a user, the prediction using, as input data, data indicative of attribute information (height, gender, age, etc.), a health condition, a degree of exercise, etc. of the user.

The information processing system 9 also makes it possible to predict a risk of rehospitalization of a patient and a risk of development of a specific disease by, for example, using, as input data, electronic health records (EHRs) (electronic medical records). In this case, the information processing system 9 makes it possible to present, to the user or a medical worker such as a doctor, a decision rule used to calculate a prediction result. This enables the user or the medical worker to understand a risk factor specified in the decision rule, and take measures against the risk factor. The information processing system 9 also makes it possible to present a measure to reduce or eliminate such a risk factor.

The information processing system 9 also makes it possible to predict a state of the spread of an infectious disease. In this case, it is only necessary to use, as input data., various kinds of data related to the spread of the infectious disease (e.g., climate data, data indicative of movement of a person, such as a travel, demographic data, data indicative of a characteristic of a target infectious disease, etc.). A decision rule presented by the information processing system 9 in this case can be a guideline for determining a measure to minimize the spread of the infectious disease. The information processing system 9 also makes it possible to present a measure to minimize the spread of the infectious disease.

### Variation

The processes described in the foregoing example embodiments and reference examples may be carried out by any entity, which is not limited to the foregoing examples. That is, an information processing system including functions similar to the functions of the information processing apparatuses 1 and 4, and the prediction apparatus 5 can be constructed by a plurality of apparatuses that can communicate with each other.

### Software Implementation Example

Some or all of functions of the information processing apparatuses 1 and 4, and the prediction apparatus 5 can be realized by hardware such as an integrated circuit (IC chip) or the like or can be alternatively realized by software.

In the latter case, the information processing apparatuses 1 and 4, and the prediction apparatus 5 are each realized by, for example, a computer that executes instructions of a program that is software realizing the functions. FIG. 8 illustrates an example of such a computer (hereinafter referred to as “computer C”). The computer C includes at least one processor C1 and at least one memory C2. The at least one memory C2 stores a program P for causing the computer C to operate as each of the information processing apparatuses 1 and 4, and the prediction apparatus 5. In the computer C, the functions of the information processing apparatuses 1 and 4, and the prediction apparatus 5 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

The whole or part of the example embodiments disclosed above can also be described as below. Note, however, that the present invention is not limited to the following supplementary notes.

### Supplementary Note 1

An information processing apparatus including: a prediction means that for a training example included in a training example set, calculates a prediction result on the basis of predicted values of k (k is a natural number of not less than 2) top-ranked decision rules which are among decision rules included in a decision list and whose conditions are satisfied by the training example; and a list determining means that by repeatedly carrying out, until a predetermined condition is satisfied by a value of an objective function including an error term indicative of an error of the prediction result, a process for updating a variable indicative of the decision list, determines the decision list to be output, the variable including a variable indicative of a decision rule which is among the decision rules whose conditions are satisfied and which is given kth priority to be used for prediction.

### Supplementary Note 2

The information processing apparatus according to Supplementary note 1, wherein the variable includes a variable indicating whether each of decision rules whose conditions are satisfied by the training example is used for prediction about the training example by the prediction means.

### Supplementary Note 3

The information processing apparatus according to Supplementary note 1 or 2, wherein the variable includes a variable indicating whether the decision list includes decision rules that are included in a decision rule set, which is a set of decision rules.

### Supplementary Note 4

The information processing apparatus according to any one of Supplementary notes 1 to 3, further comprising an acceptance means that accepts setting of a value of the k, the prediction means calculating the prediction result with use of the value of the k, the value having been accepted by the acceptance means.

### Supplementary Note 5

A prediction apparatus that carries out prediction with use of the decision list which has been determined by the information processing apparatus according to any one of Supplementary notes 1 to 4, the prediction apparatus including: an input data acquiring means that acquires input data to be subjected to prediction; and a prediction means that calculates a prediction result with use of predicted values of k top-ranked decision rules which are among the decision rules included in the decision list and whose conditions are satisfied by the input data.

### Supplementary Note 6

A machine learning method including: (a) for a training example included in a training example set, calculating a prediction result on the basis of predicted values of k (k is a natural number of not less than 2) top-ranked decision rules which are among decision rules included in a decision list and whose conditions are satisfied by the training example; and (b) by repeatedly carrying out, until a predetermined condition is satisfied by a value of an objective function including an error term indicative of an error of the prediction result, a process for updating a variable indicative of the decision list, determining the decision list to be output, (a) and (b) each being carried out by at least one processor, the variable including a variable indicative of a decision rule which is among the decision rules whose conditions are satisfied and which is given kth priority to be used for prediction.

### Supplementary Note 7

A learning program for causing a computer to function as: a prediction means that for a training example included in a training example set, calculates a prediction result on the basis of predicted values of k (k is a natural number of not less than 2) top-ranked decision rules which are among decision rules included in a decision list and whose conditions are satisfied by the training example; and a list determining means that by repeatedly carrying out, until a predetermined condition is satisfied by a value of an objective function including an error term indicative of an error of the prediction result, a process for updating a variable indicative of the decision list, determines the decision list to be output, the variable including a variable indicative of a decision rule which is among the decision rules whose conditions are satisfied and which is given kth priority to be used for prediction.

### Supplementary Note 8

The prediction apparatus according to Supplementary note 5, further including a ground presenting means that presents, as ground for the prediction result, some or all of the k top-ranked decision rules used to calculate the prediction result.

### Supplementary Note 9

The prediction apparatus according to Supplementary note 5 or 8, further including a measure presenting means that for some or all of the k top-ranked decision rules used to calculate the prediction result, presents, as support information for supporting decision making by a user, a measure for improving the prediction result.

### Supplementary Note 10

The prediction apparatus according to Supplementary note 9, wherein the prediction means calculates, with use of the input data in which an effect of the measure is reflected, a prediction result obtained by carrying out the measure, and the measure presenting means presents not only the measure but also the prediction result obtained by carrying out the measure.

### Additional Remark 3

The whole or part of the example embodiments disclosed above can also be expressed as follows. An information processing apparatus including at least one processor, the at least one processor carrying out: a prediction process for, for a training example included in a training example set, calculating a prediction result on the basis of predicted values of k (k is a natural number of not less than 2) top-ranked decision rules which are among decision rules included in a decision list and whose conditions are satisfied by the training example; and a list determining means that by repeatedly carrying out, until a predetermined condition is satisfied by a value of an objective function including an error term indicative of an error of the prediction result, a process for updating a variable indicative of the decision list, determines the decision list to be output, the variable including a variable indicative of a decision rule which is among the decision rules whose conditions are satisfied and which is given kth priority to be used for prediction.

Note that these information processing apparatuses each may further include a memory, which may store a learning program for causing the at least one processor to carry out the prediction process and the list determining process. The learning program may be stored in a non-transitory tangible computer-readable storage medium.

### REFERENCE SIGNS LIST

1, 4 Information processing apparatus
11, 404 Prediction section
12, 405 List determining section
41 Storage section
43 Input section
40 Control section
44 Output section
401 Acceptance section
402 Decision rule set generating section
403 Rank setting section
406 Input data acquiring section
411 Decision tree set
412 Decision rule set
413 Training example set
414 Decision list
5 Prediction apparatus
501 Input data acquiring section (input data acquiring means)
502 Prediction section (prediction means)
503 Ground presenting section (ground presenting means)
504 Measure presenting section (measure presenting means)

What is claimed is:

1. An information processing apparatus comprising at least one processor, the at least one processor carrying out:
a prediction process for, for a training example included in a training example set, calculating a prediction result on the basis of predicted values of k (k is a natural number of not less than 2) top-ranked decision rules which are among decision rules included in a decision list and whose conditions are satisfied by the training example; and
a list determining process for by repeatedly carrying out, until a predetermined condition is satisfied by a value of an objective function including an error term indicative of an error of the prediction result, a process for updating a variable indicative of the decision list, determining the decision list to be output,
the variable including a variable indicative of a decision rule which is among the decision rules whose conditions are satisfied and which is given kth priority to be used for prediction.

2. The information processing apparatus according to claim 1, wherein the variable includes a variable indicating whether each of decision rules whose conditions are satisfied by the training example is used for prediction about the training example by the prediction process.

3. The information processing apparatus according to claim 1, wherein the variable includes a variable indicating whether the decision list includes decision rules that are included in a decision rule set, which is a set of decision rules.

4. The information processing apparatus according to claim 1, wherein the at least one processor further carries out an acceptance process for accepting setting of a value of the k, and
in the prediction process, the at least one processor calculates the prediction result with use of the value of the k, the setting of which value has been accepted in the acceptance process.

5. A prediction apparatus that carries out prediction with use of the decision list which has been determined by the information processing apparatus according to claim 1, said prediction apparatus comprising at least one processor, the at least one processor carrying out:
an input data acquiring process for acquiring input data to be subjected to prediction; and
a prediction process for calculating a prediction result with use of predicted values of k top-ranked decision rules which are among the decision rules included in the decision list and whose conditions are satisfied by the input data.

6. A machine learning method comprising:
(a) for a training example included in a training example set, calculating a prediction result on the basis of predicted values of k (k is a natural number of not less than 2) top-ranked decision rules which are among decision rules included in a decision list and whose conditions are satisfied by the training example; and
(b) by repeatedly carrying out, until a predetermined condition is satisfied by a value of an objective function including an error term indicative of an error of the prediction result, a process for updating a variable indicative of the decision list, determining the decision list to be output,
(a) and (b) each being carried out by at least one processor,
the variable including a variable indicative of a decision rule which is among the decision rules whose conditions are satisfied and which is given kth priority to be used for prediction.

7. A non-transitory computer-readable storage medium storing therein a learning program for causing a computer to carry out:
a prediction process for, for a training example included in a training example set, calculating a prediction result on the basis of predicted values of k (k is a natural number of not less than 2) top-ranked decision rules which are among decision rules included in a decision list and whose conditions are satisfied by the training example; and
a list determining process for by repeatedly carrying out, until a predetermined condition is satisfied by a value of an objective function including an error term indicative of an error of the prediction result, a process for updating a variable indicative of the decision list, determining the decision list to be output,
the variable including a variable indicative of a decision rule which is among the decision rules whose conditions are satisfied and which is given kth priority to be used for prediction.

8. The prediction apparatus according to claim 5, wherein the at least one processor of the prediction apparatus further carries out a ground presenting process for presenting, as ground for the prediction result, some or all of the k top-ranked decision rules used to calculate the prediction result.

9. The prediction apparatus according to claim 5, wherein the at least one processor of the prediction apparatus further carries out a measure presenting process for, for some or all of the k top-ranked decision rules used to calculate the prediction result, presenting, as support information for supporting decision making by a user, a measure for improving the prediction result.

10. The prediction apparatus according to claim 9, wherein
in the prediction process, the at least one processor of the prediction apparatus calculates, with use of the input data in which an effect of the measure is reflected, a prediction result obtained by carrying out the measure, and
in the measure presenting process, the at least one processor of the prediction apparatus presents not only the measure but also the prediction result obtained by carrying out the measure.
